(19) United States
(12) Patent Application Publication
(10) Pub. No.: US 2024/0104937 A1
(43) Pub. Date: Mar. 28, 2024

(54) VEHICLE AND OBJECT RECOGNITION METHOD OF THE SAME

(71) Applicants: Hyundai Motor Company, Seoul (KR); Kia Corporation, Seoul (KR)

(72) Inventors: Jinhee Kim, Seoul (KR); Jinsol Kim, Hwaseong-Si (KR); Hyeonwoo Shim, Seoul (KR); Sangho Jeong, Seoul (KR); Jongin Son, Gwangmyeong-si (KR)

(21) Appl. No.: 18/373,675

(22) Filed: Sep. 27, 2023

(30) Foreign Application Priority Data
Sep. 28, 2022 (KR) 10-2022-0123363

(51) Int. Cl. G06V 20/58; B60W 60/00; G06V 10/50; G06V 10/56; G06V 10/77; G06V 20/40

(52) U.S. Cl. CPC G06V 20/584; B60W 60/001; G06V 10/50; G06V 10/56; G06V 10/77; G06V 20/41; B60W 2420/42; B60W 2554/402; B60W 2554/404; G06V 2201/08

(57) ABSTRACT

Vehicle and an object recognition method of the vehicle are disclosed. An object recognition method of a vehicle includes performing an object recognition of an emergency vehicle equipped with a warning light in a video recorded around the vehicle, performing a first warning light state recognition of the warning light by using a single frame of the video, performing a second warning light state recognition of the warning light by using a single frame of the video, and performing a third warning light state recognition based on a first result of the first warning light state recognition and a second result of the second warning light state recognition in a plurality of consecutive frames of the video.

### CROSS-REFERENCE TO RELATED APPLICATION(S)

This application claims the benefit of Korean Patent Application No. 10-2022-0123363, filed on Sep. 28, 2022, which application is hereby incorporated herein by reference.

### BACKGROUND

### 1. Field

The present disclosure relates to a vehicle, and to object recognition around the vehicle.

### 2. Discussion of the Background

Generally, emergency vehicles, such as a firefighting vehicle, an ambulance vehicle, or a police vehicle, are vehicles prescribed by law, and operate in accordance with the provisions of the Act for emergency services. One or more warning lights may be disposed on emergency vehicles. Warning lights may be a type of light installed on the vehicle to indicate an emergency situation. The warning lights may consist of only red color, or a combination of red and green colors, or a combination of red, green, and blue colors.

The emergency vehicles may be equipped with warning lights to inform, when an emergency situation occurs, other vehicles of an emergency situation so that the emergency vehicles drive ahead of other vehicles.

When controlling autonomous driving of a vehicle, it may be important to quickly and accurately recognize pedestrians or other vehicles around the vehicle to perform safe driving control. Accordingly, if an emergency vehicle around the vehicle appears, it is desirable to perform concession operation control if necessary.

### SUMMARY

The following summary presents a simplified summary of certain features. The summary is not an extensive overview and is not intended to identify key or critical elements.

An aspect of the disclosure provides a vehicle configured for quickly and accurately recognizing nearby emergency vehicles during autonomous vehicle driving.

Additional aspects of the disclosure will be set forth in part in the description which follows and, in part, will be obvious from the description, or may be learned by practice of the disclosure.

A method performed by at least one controller of a vehicle may comprise: determining, based on a video, a plurality of image frames associated surroundings of the vehicle; detecting, based on the plurality of image frames and by performing an object recognition process, an image of an emergency vehicle equipped with a warning light; performing, based on a first image frame of the plurality of image frames, a first warning light state recognition associated with the warning light; performing, based on a second image frame of the plurality of image frames, a second warning light state recognition associated with the warning light; and performing a third warning light state recognition based on the first warning light state recognition and the second warning light state recognition.

The performing the object recognition process may comprise extracting a warning light area in the first image frame and the second image frame of the plurality of image frames, and wherein the first image frame and the second image frame are consecutive.

The performing the first warning light state recognition may comprise determining, based on a deep learning-based warning light state recognition process, an on/off state of the warning light.

The performing the second warning light state recognition may comprise determining, based on a computer vision-based warning light state recognition process, an on/off state of the warning light.

The performing the second warning light state recognition may comprise: determining a plurality of patches in the warning light area; performing red-green-blue (RGB)-to-hue-saturation-value (HSV) conversion on each of the plurality of patches; storing, as an RGB histogram, information of pixels of which saturation (S) is greater than or equal to a predetermined value for each of the plurality of patches subjected to the RGB-to-HSV conversion; selecting a patch having the highest ratio of brightness in the RGB histogram among the plurality of patches subjected to the RGB-to-HSV conversion; and determining that the warning light is in an on state based on a value of at least one of red (R), green (G), and blue (B) channels in the RGB histogram of the selected patch being greater than or equal to a predetermined threshold.

The method may further comprise identifying three patches arranged horizontally in the warning light area.

The performing the third warning light state recognition may comprise: determining a weight based on a state determination result from the first warning light state recognition and the second warning light state recognition in each of the consecutive image frames; and determining that the warning light is in an on state based on an accumulated value of the weight for the consecutive image frames exceeding a predetermined threshold.

The method may further comprise outputting a result of the third warning light state recognition as data for an autonomous driving control of the vehicle.

A vehicle may comprise: a camera configured to capture a video comprising a plurality of image frames associated with surroundings of the vehicle; and a controller configured to: detect, based on the plurality of image frames and by performing an object recognition process, an image of an emergency vehicle equipped with a warning light; perform, based on a first image frame of the plurality of image frames, a first warning light state recognition associated with the warning light; perform, based on a second image frame of the plurality of image frames, a second warning light state recognition associated with the warning light; and perform a third warning light state recognition based on the first warning light state recognition and the second warning light state recognition.

The controller may be further configured to extract, for the object recognition process, a warning light area in the first image frame and the second image frame of the plurality of image frames, and wherein the first image frame and the second image frame are consecutive.

The controller may be further configured to perform the first warning light state recognition by determining, based on a deep learning-based warning light state recognition process, an on/off state of the warning light.

The controller may be further configured to perform the second warning light state recognition by determining, based on a computer vision-based warning light state recognition process, an on/off state of the warning light.

The controller may be, for the second warning light state recognition, further configured to: determine a plurality of patches in the warning light area; perform red-green-blue (RGB)-to-hue-saturation-value (HSV) conversion on each of the plurality of patches; store, as an RGB histogram, information of pixels of which saturation (S) is greater than or equal to a predetermined value for each of the plurality of patches subjected to the RGB-to-HSV conversion; select a patch having the highest ratio of brightness in the RGB histogram among the plurality of patches subjected to the RGB-to-HSV conversion; and determine that the warning light is in an on state based on a value of at least one of red (R), green (G), and blue (B) channels in the RGB histogram of the selected patch being greater than or equal to a predetermined threshold.

The controller may be further configured to identify three patches arranged horizontally in the warning light area.

The controller may be, for the third warning light state recognition, further configured to: determine a weight based on a state determination result from the first warning light state recognition and the second warning light state recognition in each of the consecutive image frames; and determine that the warning light is in an on state based on an accumulated value of the weight for the consecutive image frames exceeding a predetermined threshold.

The controller may be further configured to output a result of the third warning light state recognition as data for an autonomous driving control of the vehicle.

A method performed by at least one controller of a vehicle may comprise: determining, based on a video, a plurality of image frames associated surroundings of the vehicle; detecting, based on the plurality of image frames and by performing an object recognition process, an image of an emergency vehicle equipped with a warning light; and performing, based on an image frame of the plurality of image frames, a warning light state recognition associated with the warning light, wherein the warning light state recognition comprises: determining a plurality of patches in a warning light area associated with the warning light; performing, based on the plurality of patches, red-green-blue (RGB)-to-hue-saturation-value (HSV) conversion; determining, based on pixels of which saturation (S) is greater than or equal to a predetermined value for each of the plurality of patches subjected to the RGB-to-HSV conversion, an RGB histogram; selecting a patch having the highest ratio of brightness in the RGB histogram among the plurality of patches subjected to the RGB-to-HSV conversion; and determining that the warning light is in an on state based on a value of at least one of red (R), green (G), and blue (B) channels in the RGB histogram of the selected patch being greater than or equal to a predetermined threshold.

The method may further comprise identifying three patches arranged horizontally in the warning light area, wherein the plurality of patches comprises the three patches.

These and other features and advantages are described in greater detail below.

### BRIEF DESCRIPTION OF THE DRAWINGS

These and/or other aspects of the disclosure will become apparent and more readily appreciated from the following description of the present disclosure, taken in conjunction with the accompanying drawings, in which:

FIG. 1 is a view illustrating a control system of a vehicle;

FIG. 2 is a view illustrating an object recognition method of the vehicle;

FIG. 3 is a view illustrating a deep learning-based warning light state recognition process in the object recognition method of the vehicle shown in FIG. 2 in more detail;

FIG. 4 is a view illustrating a CV-based warning light state recognition process in the object recognition method of the vehicle shown in FIG. 2 in more detail;

FIG. 5 is a view illustrating a result of extracting a warning light area within a specific frame of a captured video;

FIG. 6 is a view illustrating division and conversion of the warning light area;

FIG. 7 is a view illustrating RGB histograms of entire warning light area and each of patch #1, patch #2, and patch #3;

FIG. 8 is a view illustrating a histogram distribution of each of R, G, and B channels of the selected patch #2;

FIG. 9 is a view illustrating an example of an RGB histogram according to a result (off-on) of warning light state recognition of each of two consecutive frames; and

FIG. 10 is a view illustrating another example of an RGB histogram according to a result (off-off) of warning light state recognition of each of two consecutive frames.

### DETAILED DESCRIPTION

Reference will now be made in detail to the embodiment(s) of the disclosure, examples of which are illustrated in the accompanying drawings, wherein like reference numerals refer to like elements throughout. This specification does not describe all elements of the features and detailed descriptions of what is well known in the art or redundant descriptions on substantially the same configurations have been omitted. The terms ‘part’, ‘module’, ‘member’, ‘block’ and the like as used in the specification may be implemented in software and/or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, various examples of the disclosure will be described in detail with reference to the accompanying drawings.

A user terminal may be implemented as a computer or portable terminal capable of accessing a vehicle via a network. Herein, the computer may include, for example, a laptop equipped with a web browser, a desktop, a tablet Personal Computer (PC), a slate PC, and the like. The portable terminal, for example, may include a wireless communication device that ensures portability and mobility, and may include all types of handheld-based wireless communication device such as Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, smart phone, and the like, and wearable devices such as watches, rings, bracelets, anklets, necklaces, glasses, contact lenses, head-mounted-device (HMD), and the like.

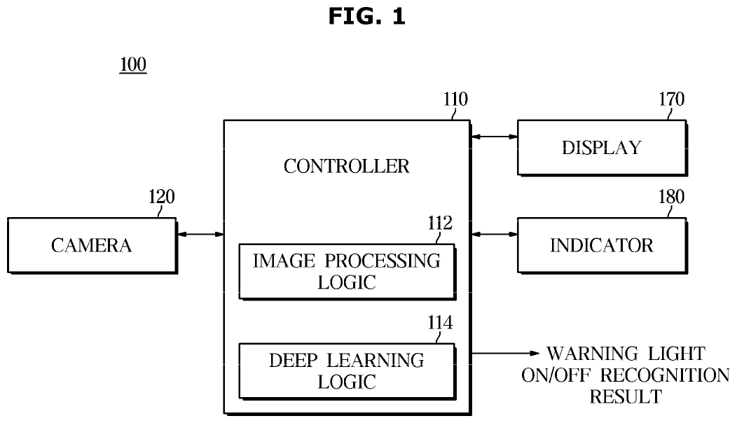

FIG. 1 is a view illustrating a control system of a vehicle.

A camera 120 may be communicatively connected to a controller 110. The camera 120 may be provided in the vehicle 100 and may be configured to capture (e.g., photograph) surroundings of the vehicle 100. One or more images generated by the image capturing of the camera 120 may be transmitted to the controller 110.

A display 170 and an indicator 180 may be communicatively installed in the controller 110. The display 170 may be provided to visually display images, notifications, alarms, and the like. The indicator 180 may be provided to display a specific situation through the lighting of light such as a light emitting diode (LED). In an example, the display 170 and/or the indicator 180 may be used to notify a driver (an occupant) of a state recognition result of warning light of an emergency vehicle. For example, when warning light of an emergency vehicle located around the vehicle 100 is turned on, a turn-on state of the warning light may be displayed through the display 170 and/or the indicator 180.

The controller 110 may include an image processing logic 112 for processing the image obtained through the camera 120 and a deep learning logic 114 for determining a state of warning light of an emergency vehicle through deep learning based on the image obtained through the camera 120. The image processing by the image processing logic 112 may also be for determining the state of the warning light of the emergency vehicle.

A result of recognizing the state of the warning light of the emergency vehicle by the controller 110 may be transmitted to other devices of the vehicle 100 and used to control the vehicle 100. For example, the result of recognizing the state of the warning light of the emergency vehicle may be used for an autonomous driving control of the vehicle 100 to allow the emergency vehicle to travel smoothly.

The controller 110 may be implemented with a memory (not shown) storing data for an algorithm and/or a program reproducing the algorithm for controlling operations of components in the vehicle 100, and a processor (not shown) performing the above-described operations using the data stored in the memory. In this case, the memory and the processor may be implemented as separate chips. Alternatively or additionally, the memory and the processor may be implemented as a single chip.

The communicator may include one or more components enabling communication with external devices, and may include, for example, at least one of: a short-range communication module, a wired communication module, and/or a wireless communication module.

The short-range communication module may include various short-range communication modules that exchange signals using a wireless communication network at a short distance, such as a Bluetooth module, an infrared communication module, a Radio Frequency Identification (RFID) communication module, a Wireless Local Access Network (WLAN) communication module, a Near Field Communication (NFC) module, a Zigbee communication module, and the like.

The wired communication modules may include various cable communications, such as Universal Serial Bus (USB), High Definition Multimedia Interface (HDMI), Digital Visual Interface (DVI), Recommended Standard (RS)-232, a power line communication, or a plain old telephone service (POTS) modules, as well as various wired communication modules, such as Controller Area Network (CAN) communication modules, Local Area Network (LAN) modules, Wide Area Network (WAN) modules, Value Added Network (VAN) modules, or the like.

The wireless communication modules may include (e.g., in addition to the WiFi module and the WiBro module) Global System for Mobile communication (GSM), Code Division Multiple Access (CDMA), Wideband Code Division Multiple Access (WCDMA), Universal Mobile Telecommunications System (UMTS), Time Division Multiple Access (TDMA), Long Term Evolution (LTE), or the like.

The wireless communication module may include a wireless communication interface including an antenna and a transmitter for transmitting signals. The wireless communication module may include a signal conversion module that modulates a digital control signal output from the controller 110 through a wireless communication interface under control of the controller 110 into an analog type of wireless signal.

The wireless communication module may include a wireless communication interface including an antenna and a receiver for receiving signals. The wireless communication module may include a signal conversion module that demodulates an analog type of wireless signal received through the wireless communication interface into a digital control signal.

The storage may be implemented as at least one of: a non-volatile memory device such as a cache, a Read Only Memory (ROM), a Programmable ROM (PROM), an erasable programmable ROM (EPROM), an Electrically Erasable Programmable ROM (EEPROM), and a flash memory, or a volatile memory device such as a Random Access Memory (RAM), or a storage medium such as a Compact Disk (CD)-ROM, but aspects of the present disclosure are not limited thereto. The storage may be a memory implemented as a separate chip from the processor described above in relation to the controller 110, and/or may be implemented as a single chip with the processor.

The display 170 may include a Cathode Ray Tube (CRT), a Digital Light Processing (DLP) panel, a Plasma Display Panel (PDP), a Liquid Crystal Display (LCD) panel, an Electro Luminescence (EL) panel, an Electrophoretic Display (EPD) panel, an Electrochromic Display (ECD) panel, a Light Emitting Diode (LED) panel, Organic Light Emitting Diode (OLED) panel, or the like, but aspects of the present disclosure are not limited thereto.

An input device (e.g., including an input interface) may include hardware devices such as various buttons, switches, pedals, keyboards, mice, track-balls, various levers, handles, and/or sticks for user input.

The input device may include a Graphical User Interface (GUI), e.g., a software device, such as a touch pad for user input. The touch pad may be implemented as a Touch Screen Panel (TSP) and may form a multiple layer structure with the display.

When composed of TSP forming a multiple layer structure with a touch pad, the display may also be used as an input device.

At least one component may be added or deleted to correspond to performance of components of the vehicle 100 shown in FIG. 1. It would be understood by those skilled in the art that mutual positions of the components may be changed corresponding to the performance or structure of the system.

In some implementations, at least one component of the elements shown in FIG. 1 may be implemented as software and/or hardware components such as a Field Programmable Gate Array (FPGA) and an Application Specific Integrated Circuit (ASIC).

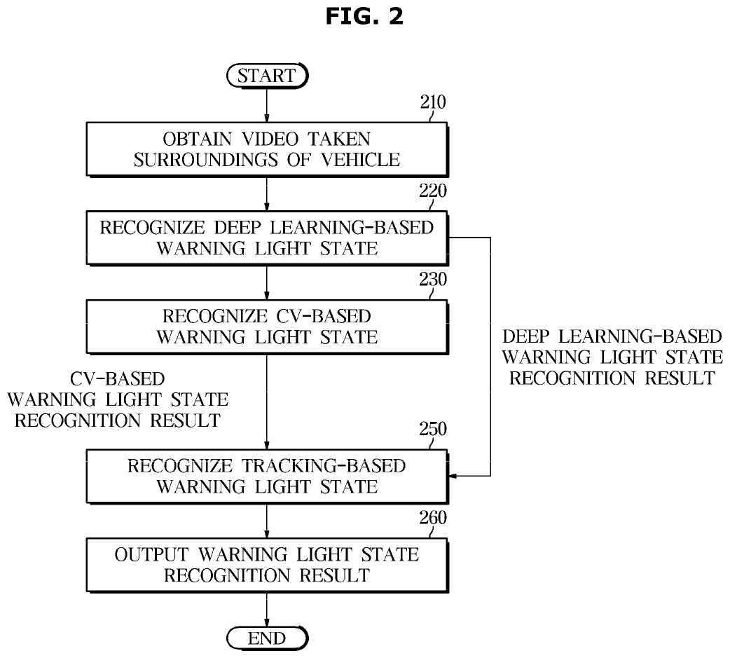

FIG. 2 is a view illustrating an object recognition method of a vehicle. The object recognition method of the vehicle 100 shown in FIG. 2 may identify whether an emergency vehicle appears around the vehicle 100 and identify the state of the warning light of the emergency vehicle. The object recognition method of the vehicle shown in FIG. 2 may be performed through the device configuration shown in FIG. 1.

To recognize one or more objects located around the vehicle 100, the controller 110 may obtain a video recorded surroundings of the vehicle 100 using the camera 120 provided in the vehicle 100 (210). An object to be recognized as object may include other vehicles, pedestrians, animals, buildings, lanes, and the like. For example, other vehicles may include an emergency vehicle. The emergency vehicle may be a vehicle prescribed by law, such as a firefighting vehicle, an ambulance vehicle, or a police vehicle. The emergency vehicles may be provided with a warning light emitter. The warning light emitter, as a type of light emitter, may be disposed above the vehicle and may be provided to inform an emergency situation through flashing if necessary. The color of the warning light, for example, may consist of only red, or a combination of red and green, or a combination of red, green, and blue.

The controller 110 may perform a deep learning-based warning light state recognition process based on the video of the surroundings of the vehicle 100 (220). For example, the controller 110 may identify an emergency vehicle by analyzing a video taken around the vehicle 100 through deep learning in the deep learning-based warning light state recognition process 220. In response to the emergency vehicle being recognized, the controller 110 may determine whether the warning light of the corresponding emergency vehicle is on or off. The on state of the warning light may be a state in which the warning light repeatedly flickers. The off state of the warning light may be a state in which the warning light does not flicker. The emergency vehicles may be prescribed to turn off the warning light in non-emergency situations and keep the warning light on only in emergency situations. When the warning light of the emergency vehicle is turned on, the situation may be an emergency situation and thus it is necessary to be considerate so that the emergency vehicle may proceed.

The controller 110 may perform a computer vision (CV)-based warning light state recognition process based on the video of the surroundings of the vehicle 100 (230). For example, the controller 110 may identify an emergency vehicle by analyzing a video taken around the vehicle 100 through image processing in the CV-based warning light state recognition process 230. In response to the emergency vehicle being recognized, the controller 110 may determine whether the warning light of the corresponding emergency is on or off. The on state of the warning light may be a state in which the warning light repeatedly flickers. The off state of the warning light may be a state in which the warning light does not flicker. The emergency vehicles may be prescribed to turn off the warning light in non-emergency situations and keep the warning light on only in emergency situations. When the warning light of the emergency vehicle is turned on, the corresponding situation may be an emergency situation and thus it is necessary to be considerate so that the emergency vehicle may proceed.

The deep learning-based warning light state recognition process 220 and/or the CV-based warning light state recognition process 230 described above may be performed based on a frame-by-frame basis (e.g., the video images of the surroundings of the vehicle 100 may be divided into frame units of the recorded video and the deep learning-based warning light state recognition process 220 and the CV-based warning light state recognition process 230 may be performed based on the frame units). For example, the deep learning-based warning light state recognition process 220 and the CV-based warning light state recognition process 230 may be performed for each frame of the video taken around the vehicle 100.

The controller 110 may perform a tracking-based warning light state recognition (250). As described above, the deep learning-based warning light state recognition process 220 and/or the CV-based warning light state recognition process 230 may be performed based on a frame-by-frame basis (e.g., the video images of the surroundings of the vehicle 100 may be divided into frame units of the recorded video and the deep learning-based warning light state recognition process 220 and the CV-based warning light state recognition process 230 may be performed based on each of the frame units). In the tracking-based warning light state recognition process, an additional recognition of the warning light state of the emergency vehicle may be performed by using the previously performed results (e.g., both of a result of the deep learning-based warning light state recognition, which is the result of the previously performed deep learning-based warning light state recognition process 220, and a result of the CV-based based warning light state recognition process, which is the result of the previously performed CV-based warning light state recognition process 230). For example, in the tracking-based warning light state recognition process, a recognition of the warning light state of the emergency vehicle may be performed based on a plurality of the results of the deep learning-based warning light state recognition and a plurality of the results of the CV-based warning light state recognition targeting a plurality of consecutive frames (i.e., tracking-based).

In response to the warning light state recognition of the emergency vehicle being completed, the controller 110 may output the result of the warning light state recognition as data for an autonomous driving control (260). The result of the warning light state recognition may be in the form of a flag. For example, the on state of the warning light may be represented by a first value (e.g., 1 or any other value), the off state of the warning light is represented by a second value (e.g., 0 or any other value), and when not detected, it may be represented by a third value (e.g., −1 or any other value). The result of the warning light state recognition may be used to control devices related to autonomous driving of the vehicle 100. The devices related to autonomous driving of the vehicle 100 may control the behavior of the vehicle 100, for example, based on the result of the warning light state recognition provided from the controller 110. For example, the devices related to autonomous driving of the vehicle 100 may control, upon determining that the warning light of the emergency vehicle is on-state, an autonomous driving path of the vehicle 100 to change to a shoulder or any other lane so that the emergency vehicle driving with the on-state of the warning light may proceed first. Alternatively or additionally, the devices related to autonomous driving of the vehicle 100 may control the vehicle 100 to temporarily stop the vehicle 100 at the current location upon determining that the warning light of the emergency vehicle is on-state.

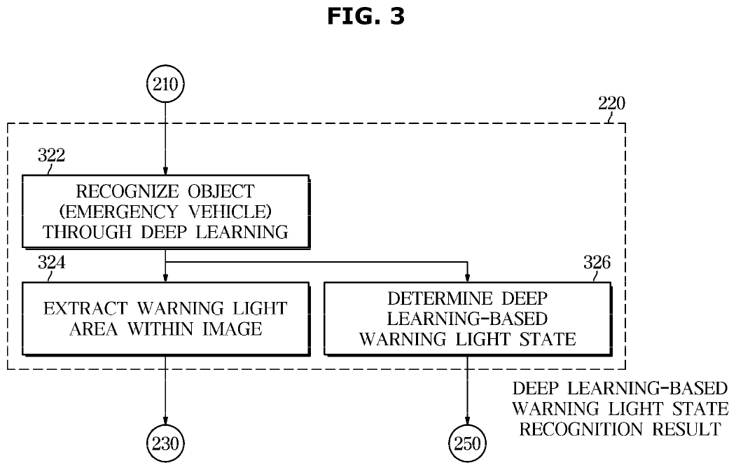

FIG. 3 is a view illustrating the deep learning-based warning light state recognition process in the vehicle object recognition method shown in FIG. 2 in more detail.

In the deep learning-based warning light state recognition process 220, the controller 110 may recognize an object (e.g., an emergency vehicle) in the captured video by performing deep learning image recognition based on the video taken around the vehicle 100 (322).

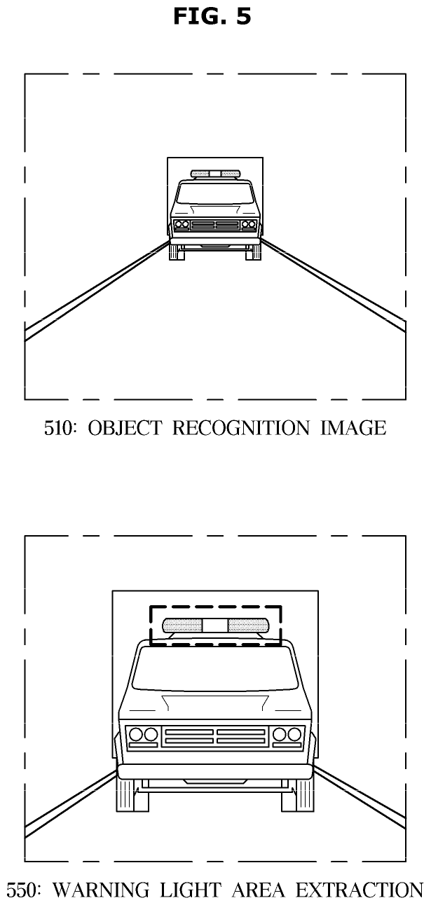

In response to the emergency vehicle being recognized, the controller 110 may extract a warning light area of the emergency vehicle in the image for which object recognition has been completed (324). FIG. 5 is a view illustrating a result of extracting the warning light area within a specific frame of the recorded video. In FIG. 5, reference numeral 510 indicates the result of recognizing the emergency vehicle as the object, and reference numeral 550 indicates the result of extracting the warning light area. An object detection model (e.g., CenterNet model) may be used to extract the warning light area. In CenterNet model, upon inputting an image, the deep learning by comparing the center point of an object and the values of the width and height of the object with the corresponding values of ground truth (GT) is performed. From the result of deep learning, information (e.g., width and height, location of center point) of a bounding box of the warning light area may be extracted.

Returning to FIG. 3, in response to the warning light area of the emergency vehicle being extracted, the controller 110 may perform a determination of the deep learning-based warning light state for the warning light area (326). For example, the controller 110, in the deep learning-based warning light state recognition process 220, may identify the emergency vehicle by analyzing the video taken around the vehicle 100 through deep learning. In response to the emergency vehicle being recognized, the controller 110 may determine whether the warning light of the corresponding emergency vehicle is on-state or off-state. If the identification on on/off state of the warning light is unavailable, the controller 110 may determine the state of the warning light as ‘not detected’. To determine the on/off state of the warning light, a convolutional neural network (CNN) and/or any other learning algorithms may be used.

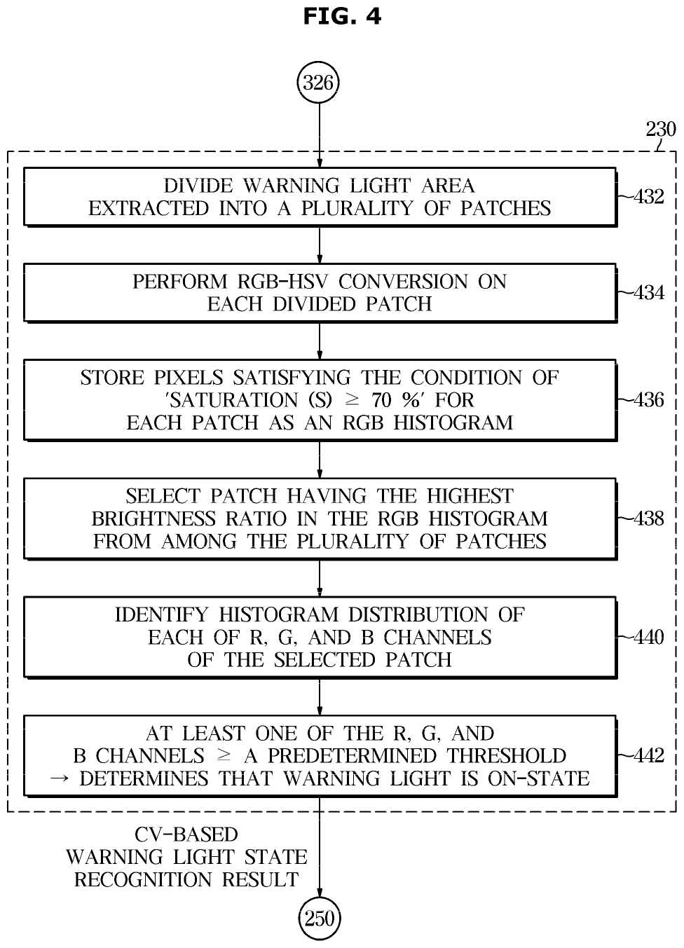

FIG. 4 is a view illustrating the CV-based warning light state recognition process in the vehicle object recognition method of the vehicle shown in FIG. 2 in more detail.

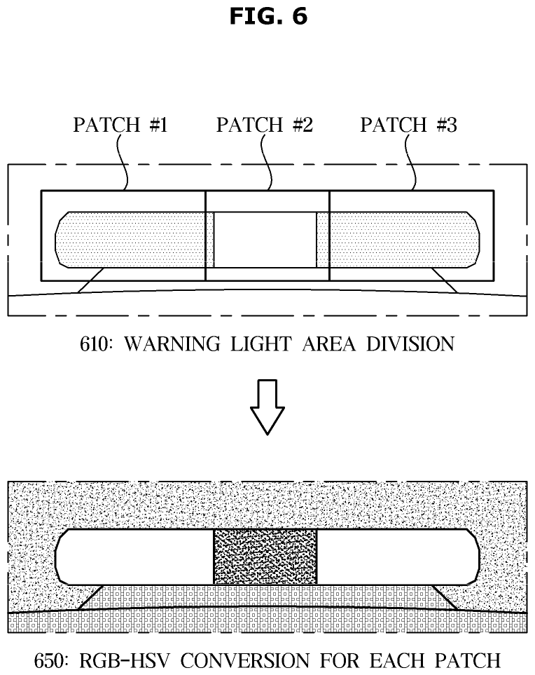

In the CV-based warning light state recognition process, the controller 110 may divide the warning light area extracted in 324 of FIG. 3 into a plurality of patches (432). FIG. 6 is a view illustrating division and conversion of the warning light area. Reference numeral 610 in FIG. 6 indicates the result of dividing the warning light area into three horizontally. The three patches generated by the 3-partition may be represented by patch #1, patch #2, and patch #3, respectively.

Returning to FIG. 4, the controller 110 may perform an RGB-HSV conversion on each of the divided patches (434). Reference numeral 650 in FIG. 6 indicates a result of converting each patch of the warning light area from RGB to HSV. RGB expresses an image with the three primary colors of Red-Green-Blue, and HSV expresses an image with Hue-Saturation-Value (light). The reason for converting RGB to HSV is to remove the room for erroneous judgment in the RGB format through conversion to HSV. For example, there may be a case where light smearing is mixed in the warning light portion due to presence of a white steel frame supporting the warning light and/or excessive light incident on the image. In this case, it may be difficult to distinguish colors in the RGB format (because bright pixels are included even when the warning light is off). Accordingly, when the analysis is performed through the saturation (S) of HSV, white structures other than the warning light or light smudges have a relatively lower value (0 to 30%) than the saturation (70% or more) of the warning light, so that analyzing through HSV may determine the state of the warning light more accurately than analyzing through RGB. Prior to the conversion from RGB to HSV, the warning light area may be subjected to Gaussian Blur and Dilate. The Gaussian Blur is to reduce noise caused by excessive light when the warning light is too bright. The Dilate is to increase the number of pixels in the warning light area for determining the state of the warning light by dilating the periphery of a portion determined to be the warning light area in the image to increase the number of pixels in the warning light area.

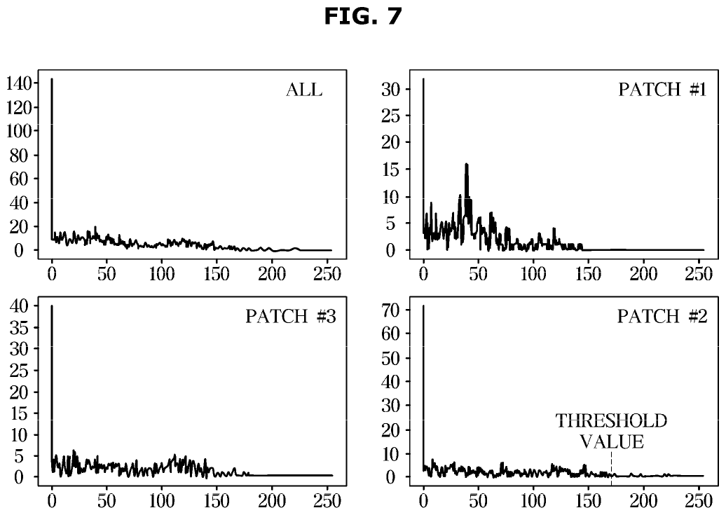

Returning to FIG. 4, the controller 110 may store pixels satisfying the condition of ‘saturation (S)≥70%’ for each patch as an RGB histogram (436). FIG. 7 is a view illustrating RGB histograms of the entire warning light area and each of patch #1, patch #2, and patch #3. The reason for storing the pixels satisfying the condition of ‘saturation (S)≥70%’ as the RGB histogram is, as above-mentioned in the description of FIG. 4, to more accurately determine the state of the warning light based on the saturation (S).

Returning to FIG. 4, the controller 110 may select a patch having the highest brightness ratio in the RGB histogram from among the plurality of patches (438). In FIG. 7 described above, patch #2 is a patch having the highest brightness ratio in the RGB histogram.

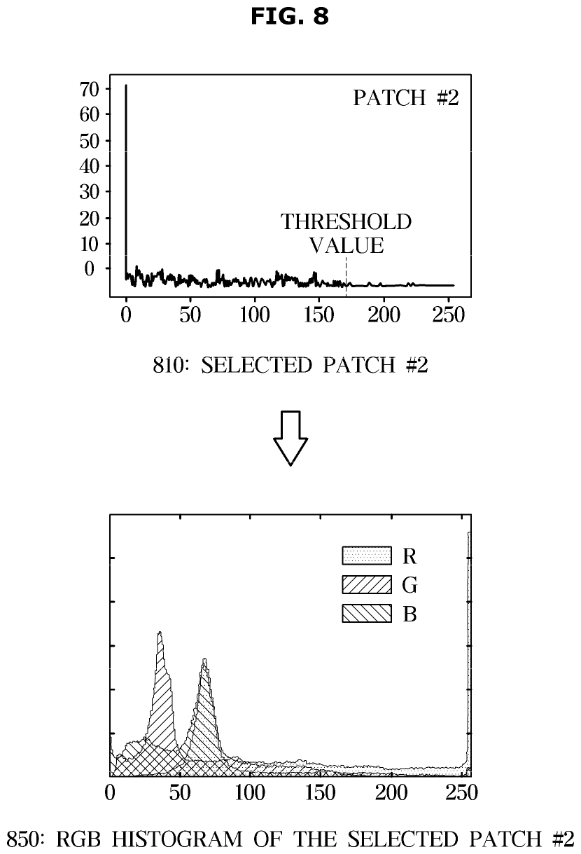

When the patch having the highest proportion of bright values in the RGB histogram is selected, the controller 110 may identify histogram distribution of each of R, G, and B channels of the selected patch (patch #2) (440). FIG. 8 is a view illustrating the histogram distribution of each of the R, G, and B channels of the selected patch #2. In FIG. 8, reference numeral 810 indicates an RGB histogram of the selected patch #2, and reference numeral 850 indicates the histogram distributions of R, G, and B channels of the selected patch #2.

Returning to FIG. 4, if the value of at least one of the R, G, and B channels as shown in FIG. 8 is greater than or equal to a predetermined threshold (channel value≥threshold value), the controller 110 may determine that the warning light is in on-state (442). In an example, the distributions of the histogram may be grasped through the average of the top 30 histogram values for each of the R channel, the G channel, and the B channel. In an example, the predetermined threshold may be determined based on the highest score indicating that the warning light is on-state in quantitative evaluation and qualitative evaluation through experiments.

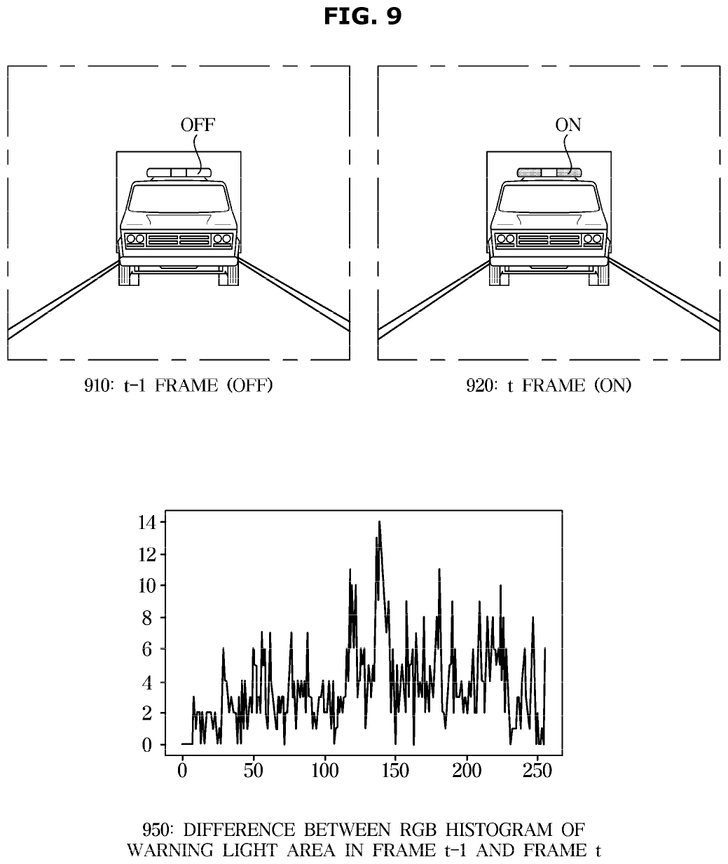

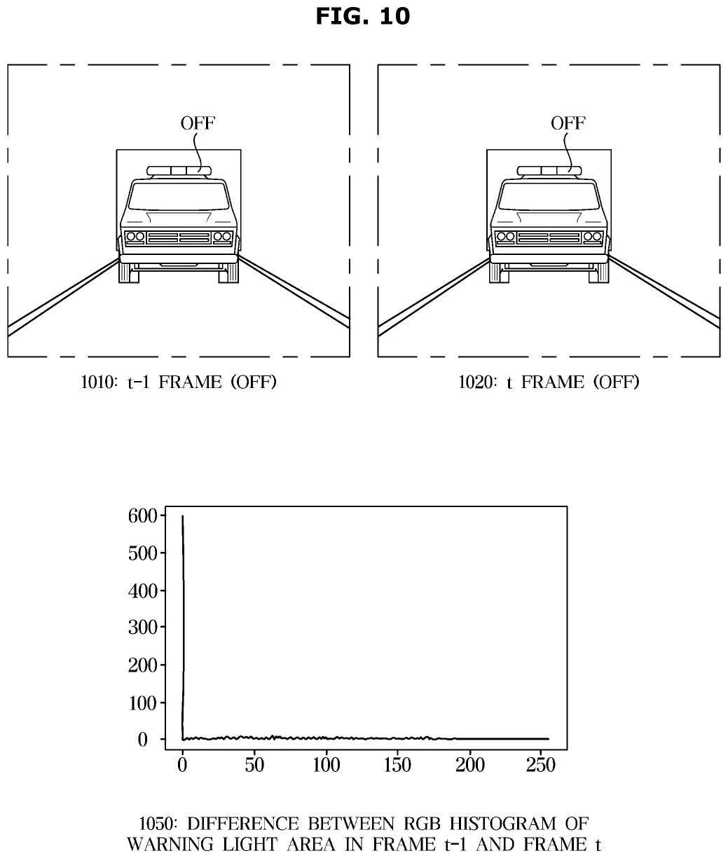

FIGS. 9 and 10 are views illustrating the tracking-based warning light state recognition process. In the description of FIG. 2, it has been described that in the tracking-based warning light state recognition process, the recognition of the warning light state of the emergency vehicle may be performed by using both of a result of the deep learning-based warning light state recognition, which is the result of the previously performed deep learning-based warning light state recognition process 220, and a result of the CV-based based warning light state recognition process, which is the result of the previously performed CV-based warning light state recognition process 230.

In the tracking-based warning light state recognition process, the result of recognizing the state of the warning light may be finally obtained by synthesizing the on/off determination results from the result of the deep learning-based warning light state recognition and the result of the CV-based warning light state recognition in each of a plurality of consecutive frames (for example, ten frames). The result of the warning light state recognition may be transmitted to a sensor fusion of the vehicle 100. The threshold may be set to a value capable of determining the on-state of the warning light obtained through an experiment.

FIG. 9 is a view illustrating an example of an RGB histogram according to results (off-on) of the warning light state recognition of each of two consecutive frames. In FIG. 9, the warning light is off in a previous frame t−1 (910), and the warning light is on in a current frame t (920). As such, when the values of the warning light state in each of two adjacent frames are different from off and on, the difference between the RGB histogram of the warning light area in the image at this time is very large, as indicated by reference numeral 950. FIG. 10 is a view illustrating an example of an RGB histogram according to the results (off-off) of the warning light state recognition of each of two consecutive frames. In FIG. 10, the warning light is off in the previous frame t−1 (1010) and the warning light is off in the current frame t (1020). As such, if the values of the warning light state in each of the two neighboring frames are identical to off, the difference between the RGB histogram of the warning light area in the image at this time is very small, as indicated by reference numeral 1050. In other words, the on/off state of the warning light may be identified from the difference of RGB histograms between two adjacent frames.

Alternatively or additionally, a weight may be given based on the result of the deep learning-based warning light state recognition and the result of the CV-based warning light state recognition. The weight may be accumulated according to the recognition result in each of the plurality of consecutive frames, and if the accumulated weight exceeds a predetermined threshold, the controller 110 may determine that the warning light of the emergency vehicle is in on-state. For example, in each of the deep learning-based warning light state recognition and the CV-based warning light state recognition, if the weight when it is determined that the warning light is in on-state is 0.5 and the weight when it is determined that the warning light is in off-state is 0.0, the sum of the weights according to the determination results of the deep learning-based warning light state recognition and the CV-based warning light state recognition is as follows.

All off: sum of weights=0+0=0

Only one on: Sum of weights=0+0.5=0.5

All on: Sum of weights=0.5+0.5=1

The weights may be accumulated after performing the above processes for a plurality of frames (e.g., 10 frames), and when the accumulated weights are greater than or equal to a predetermined value, it may be determined that the warning light is in on-state. Herein, the predetermined value may be determined as a reference value capable of indicating that the warning light is on through an experiment.

In accordance with an aspect of the disclosure, an object recognition method of a vehicle is provided. The object recognition method includes performing an object recognition of an emergency vehicle equipped with a warning light in a video recorded around the vehicle, performing a first warning light state recognition of the warning light by using a single frame of the video, performing a second warning light state recognition of the warning light by using a single frame of the video, and performing a third warning light state recognition based on a first result of the first warning light state recognition and a second result of the second warning light state recognition in a plurality of consecutive frames of the video.

The performing of the object recognition may further include extracting a warning light area within the single frame.

The first warning light state recognition may include determining an on/off state of the warning light through a deep learning-based warning light state recognition.

The second warning light state recognition may include determining an on/off state of the warning light through a computer vision-based warning light state recognition.

The second warning light state recognition may further include dividing the warning light area into a plurality of patches, performing red-green-blue (RGB)-hue-saturation-value (HSV) conversion on each of the plurality of patches, storing pixels whose saturation (S) is greater than or equal to a predetermined value for each of the plurality of patches subjected to the RGB-HSV conversion as an RGB histogram, selecting a patch having the highest ratio of brightness in the RGB histogram among the plurality of patches subjected to the RGB-HSV conversion, and determining that the warning light is in on-state when a value of at least one of the R, G, and B channels in the RGB histogram of the selected patch is greater than or equal to a predetermined threshold.

The dividing of the warning light area may include dividing the warning light area into three horizontally.

The third warning light state recognition may further include receiving a weight based on a state determination result from a result of the first warning light state recognition and a result of the second warning light state recognition in each of the plurality of consecutive frames, and determining that the warning light is in on-state when an accumulated value of the weight in the plurality of consecutive frames exceeds a predetermined threshold.

The method may further include outputting a third result of the third warning light state recognition as data for an autonomous driving control of the vehicle.

In accordance with an aspect of the disclosure, a vehicle includes a camera configured to capture surroundings of the vehicle, a controller configured to perform an object recognition of an emergency vehicle equipped with a warning light in a video taken around the vehicle, perform a first warning light state recognition of the warning light by using a single frame of the video, perform a second warning light state recognition of the warning light by using a single frame of the video, and perform a third warning light state recognition based on a first result of the first warning light state recognition and a second result of the second warning light state recognition in a plurality of consecutive frames of the video.

The controller may extract, in the object recognition, a warning light area within the single frame.

The first warning light state recognition may include determining an on/off state of the warning light through a deep learning-based warning light state recognition.

The second warning light state recognition may include determining an on/off state of the warning light through a computer vision-based warning light state recognition.

The controller may be, in the second warning light state recognition, further configured to divide the warning light area into a plurality of patches, perform red-green-blue (RGB)-hue-saturation-value (HSV) conversion on each of the plurality of patches, store pixels whose saturation (S) is greater than or equal to a predetermined value for each of the plurality of patches subjected to the RGB-HSV conversion as an RGB histogram, select a patch having the highest ratio of brightness in the RGB histogram among the plurality of patches subjected to the RGB-HSV conversion, and determine that the warning light is in on-state when a value of at least one of the R, G, and B channels in the RGB histogram of the selected patch is greater than or equal to a predetermined threshold.

The dividing of the warning light area may include dividing the warning light area into three horizontally.

The controller may be, in the third warning light state recognition, further configured to receive a weight based on a state determination result from a result of the first warning light state recognition and a result of the second warning light state recognition in each of the plurality of consecutive frames, and determine that the warning light is in on-state when an accumulated value of the weight in the plurality of consecutive frames exceeds a predetermined threshold.

The controller may output a third result of the third warning light state recognition as data for an autonomous driving control of the vehicle.

In accordance with an aspect of the disclosure, an object recognition method of a vehicle is provided. The object recognition method include performing an object recognition of an emergency vehicle equipped with a warning light in a video taken around the vehicle, and performing a warning light state recognition of the warning light by using a single frame of the video, wherein the warning light state recognition includes dividing a warning light area into a plurality of patches, performing red-green-blue (RGB)-hue-saturation-value (HSV) conversion on each of the plurality of patches, storing pixels whose saturation (S) is greater than or equal to a predetermined value for each of the plurality of patches subjected to the RGB-HSV conversion as an RGB histogram, selecting a patch having the highest ratio of brightness in the RGB histogram among the plurality of patches subjected to the RGB-HSV conversion, and determining that the warning light is in on-state when a value of at least one of the R, G, and B channels in the RGB histogram of the selected patch is greater than or equal to a predetermined threshold.

In accordance with an aspect of the disclosure, an object recognition method of a vehicle is provided. The object recognition method includes performing an object recognition of an emergency vehicle equipped with a warning light in a video taken around the vehicle, and determining an on/off state of the warning light through a computer vision-based warning light state recognition by using a single frame of the video.

The warning light state recognition may further include dividing a warning light area into a plurality of patches, performing red-green-blue (RGB)-hue-saturation-value (HSV) conversion on each of the plurality of patches, storing pixels whose saturation (S) is greater than or equal to a predetermined value for each of the plurality of patches subjected to the RGB-HSV conversion as an RGB histogram, selecting a patch having the highest ratio of brightness in the RGB histogram among the plurality of patches subjected to the RGB-HSV conversion, and determining that the warning light is in on-state when a value of at least one of the R, G, and B channels in the RGB histogram of the selected patch is greater than or equal to a predetermined threshold.

The dividing of the warning light area may include dividing the warning light area into three horizontally.

As is apparent from the above, according to various examples of the disclosure, the vehicle, while autonomous driving, may quickly and accurately recognize a nearby emergency vehicle, in particular an on/off state of the warning light installed in the emergency vehicle.

The above-described features may be implemented in the form of a recording medium storing instructions executable by a computer. The instructions may be stored in the form of program code. When the instructions are executed by a processor, a program module is generated by the instructions so that the operations of the illustrated features may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although various examples of the disclosure have been shown and described, it would be appreciated by those having ordinary skill in the art that changes may be made without departing from the principles and spirit of the disclosure, the scope of which is defined in the claims and their equivalents.

What is claimed is:

1. A method performed by at least one controller of a vehicle, the method comprising:
determining, based on a video, a plurality of image frames associated surroundings of the vehicle;
detecting, based on the plurality of image frames and by performing an object recognition process, an image of an emergency vehicle equipped with a warning light;
performing, based on a first image frame of the plurality of image frames, a first warning light state recognition associated with the warning light;
performing, based on a second image frame of the plurality of image frames, a second warning light state recognition associated with the warning light; and
performing a third warning light state recognition based on the first warning light state recognition and the second warning light state recognition.

2. The method of claim 1, wherein the performing the object recognition process comprises extracting a warning light area in the first image frame and the second image frame of the plurality of image frames, and wherein the first image frame and the second image frame are consecutive.

3. The method of claim 1, wherein the performing the first warning light state recognition comprises determining, based on a deep learning-based warning light state recognition process, an on/off state of the warning light.

4. The method of claim 1, wherein the performing the second warning light state recognition comprises determining, based on a computer vision-based warning light state recognition process, an on/off state of the warning light.

5. The method of claim 2, wherein the performing the second warning light state recognition comprises:
determining a plurality of patches in the warning light area;
performing red-green-blue (RGB)-to-hue-saturation-value (HSV) conversion on each of the plurality of patches;
storing, as an RGB histogram, information of pixels of which saturation (S) is greater than or equal to a predetermined value for each of the plurality of patches subjected to the RGB-to-HSV conversion;
selecting a patch having the highest ratio of brightness in the RGB histogram among the plurality of patches subjected to the RGB-to-HSV conversion; and
determining that the warning light is in an on state based on a value of at least one of red (R), green (G), and blue (B) channels in the RGB histogram of the selected patch being greater than or equal to a predetermined threshold.

6. The method of claim 2, further comprising identifying three patches arranged horizontally in the warning light area.

7. The method of claim 2, wherein the performing the third warning light state recognition comprises:
determining a weight based on a state determination result from the first warning light state recognition and the second warning light state recognition in each of the consecutive image frames; and
determining that the warning light is in an on state based on an accumulated value of the weight for the consecutive image frames exceeding a predetermined threshold.

8. The method of claim 1, further comprising outputting a result of the third warning light state recognition as data for an autonomous driving control of the vehicle.

9. A vehicle comprising:
a camera configured to capture a video comprising a plurality of image frames associated with surroundings of the vehicle; and
a controller configured to:
detect, based on the plurality of image frames and by performing an object recognition process, an image of an emergency vehicle equipped with a warning light;
perform, based on a first image frame of the plurality of image frames, a first warning light state recognition associated with the warning light;
perform, based on a second image frame of the plurality of image frames, a second warning light state recognition associated with the warning light; and
perform a third warning light state recognition based on the first warning light state recognition and the second warning light state recognition.

10. The vehicle of claim 9, wherein the controller is further configured to extract, for the object recognition process, a warning light area in the first image frame and the second image frame of the plurality of image frames, and wherein the first image frame and the second image frame are consecutive.

11. The vehicle of claim 9, wherein the controller is further configured to perform the first warning light state recognition by determining, based on a deep learning-based warning light state recognition process, an on/off state of the warning light.

12. The vehicle of claim 9, wherein the controller is further configured to perform the second warning light state recognition by determining, based on a computer vision-based warning light state recognition process, an on/off state of the warning light.

13. The vehicle of claim 10, wherein the controller is, for the second warning light state recognition, further configured to:
determine a plurality of patches in the warning light area;
perform red-green-blue (RGB)-to-hue-saturation-value (HSV) conversion on each of the plurality of patches;
store, as an RGB histogram, information of pixels of which saturation (S) is greater than or equal to a predetermined value for each of the plurality of patches subjected to the RGB-to-HSV conversion;
select a patch having the highest ratio of brightness in the RGB histogram among the plurality of patches subjected to the RGB-to-HSV conversion; and
determine that the warning light is in an on state based on a value of at least one of red (R), green (G), and blue (B) channels in the RGB histogram of the selected patch being greater than or equal to a predetermined threshold.

14. The vehicle of claim 10, wherein the controller is further configured to identify three patches arranged horizontally in the warning light area.

15. The vehicle of claim 10, wherein the controller is, for the third warning light state recognition, further configured to:
determine a weight based on a state determination result from the first warning light state recognition and the second warning light state recognition in each of the consecutive image frames; and
determine that the warning light is in an on state based on an accumulated value of the weight for the consecutive image frames exceeding a predetermined threshold.

16. The vehicle of claim 9, wherein the controller is further configured to output a result of the third warning light state recognition as data for an autonomous driving control of the vehicle.

17. A method performed by at least one controller of a vehicle, the method comprising:
determining, based on a video, a plurality of image frames associated surroundings of the vehicle;
detecting, based on the plurality of image frames and by performing an object recognition process, an image of an emergency vehicle equipped with a warning light; and
performing, based on an image frame of the plurality of image frames, a warning light state recognition associated with the warning light,
wherein the warning light state recognition comprises:
determining a plurality of patches in a warning light area associated with the warning light;
performing, based on the plurality of patches, red-green-blue (RGB)-to-hue-saturation-value (HSV) conversion;
determining, based on pixels of which saturation (S) is greater than or equal to a predetermined value for each of the plurality of patches subjected to the RGB-to-HSV conversion, an RGB histogram;
selecting a patch having the highest ratio of brightness in the RGB histogram among the plurality of patches subjected to the RGB-to-HSV conversion; and
determining that the warning light is in an on state based on a value of at least one of red (R), green (G), and blue (B) channels in the RGB histogram of the selected patch being greater than or equal to a predetermined threshold.

18. The method of claim 17, further comprising identifying three patches arranged horizontally in the warning light area, wherein the plurality of patches comprises the three patches.
